(19) United States
(12) Patent Application Publication
(10) Pub. No.: US 2014/0365282 A1
(43) Pub. Date: Dec. 11, 2014

(54) Web-based System and Process for Creating Child Entities While Incentivizing Users to Engage in Positive Behavior

(71) Applicant: William J. DiGrazio, JR., Rochester, NY (US)

(72) Inventor: William J. DiGrazio, JR., Rochester, NY (US)

(21) Appl. No.: 14/298,167

(22) Filed: Jun. 6, 2014

Related U.S. Application Data
(60) Provisional application No. 61/832,381, filed on Jun. 7, 2013.

(51) Int. Cl. G06Q 30/02

(52) U.S. Cl. CPC G06Q 30/0279; G06Q 30/0208
USPC 705/12; 705/14.11

(57) ABSTRACT

A web-based system for creating a potentially endless stream of Child Entities which incentivizes users to participate in the creation of a Child Entity which may be a charitable organization at a variety of levels including helping select the people who will help lead or direct the activities of the Child Entity based on the merits of their life activities demonstrated through the system.

### BACKGROUND OF THE INVENTION

The present invention broadly relates to a web-based incentive system and process which encourages people to engage in positive behavior (e.g., acts of benevolence). In one exemplary embodiment, the invention relates to a web-based system which incentivizes people to engage in positive behavior which is directly linked to the creation of new charitable entities. Although the main embodiment set forth herein to describe the inventive system relates to the formation of charitable entities, it is understood that the system has broad applicability to any desired subject matter and/or purpose including non-charitable entities, job creation, rewards, etc.

Charitable entity formation has historically been performed on an individual basis, i.e., a person or group decides to form a charitable entity directed to a cause of their choice.

Donating to charity is a rewarding experience, both for the individual that gives, as they obtain a feeling of pride and joy from their benevolence, and also for the eventual recipient of the donations, as their situation would most likely be made better off than had they not received the benefit from the donation. This was the 20th century version of charitable giving. However, this new and innovative process and system will take charitable giving into the 21st century by transforming charitable giving into benevolent living.

### SUMMARY OF THE INVENTION

An embodiment of the inventive process and system provides a mechanism for creating Child Entities for the purpose of distributing the donations raised through the system, generating employment opportunities within the Child Entity for the individuals that demonstrate they are themselves benevolent human beings, and incentivizing users of the system to perform activities in their lives that others will view in high regard in an attempt to hopefully influence other users to vote for them to have the opportunity to work in the Child Entity. Individuals will use the system to log their benevolent activities and assess others' activities so that the system can generate at the least a merit rating that could be used in the selection process by which the users vote for those they think would be the best candidates to interview with the Parent Entity for the opportunity to be chosen into the available job positions in the Child Entity. So, in the 20th century there was a donator and a recipient. With the inventive process and system, there is still a donator and a recipient, but now in the 21st century the donator is incentivized to perform more activities that others will view as highly desired through the competitive nature of demonstrating one's worthiness to receive a job that will be responsible for distributing the raised charitable donations to worthy charitable causes. This unique approach has the potential to transcend the charity landscape.

In one aspect, the inventive system provides a process by which Child Entities (charitable or non-charitable) may be created in potentially perpetual fashion with the oversight of a single Parent Entity. It is understood the term “entity” or “entities” as used herein includes any legally recognized business organization or entity type which may or may not be linked to or a part of another entity of the same or different type (e.g., the Child Entity may be part of the Parent Entity as a division, work group, team, business unit, etc.). It is further understood that while the Child Entity described herein is referred to as a charitable entity, the invention is also applicable to non-charitable entities.

The system may be web-based and made available to anyone with an internet connection (the “users”). The system may include a robust authentication process that could enable dual-factor authentication as well as other secure methodologies to ensure the integrity and safety of the financial transactions and user information. The process begins with the Parent Entity creating a web-based system that presents a website on which the Child Entity creation system (hereinafter sometimes referred to as “CECS”) is managed and users may access via an internet connection. Examples of basic steps in the process of creating a single Child Entity (hereinafter sometimes referred to herein as a “Child Entity Creation Event”) may include the following (in no particular order):
a) allowing a user to register or simply browse the CECS website;
b) allowing users to make monetary donations to the parent entity which will fund the charitable Child Entity;
c) allowing a registered user to log their own and/or another user's personal activities (the term “personal activities” means anything a human is capable of doing including, for example, benevolent acts (e.g., donating to Goodwill, helping someone in distress, fostering stray animals, volunteering your time for a good cause, making personal sacrifices for the benefit of others, etc.), creation of art, manufacturing of objects, writing, playing sports, etc., on the system;
d) allowing users to verify the personal activities of themselves and/or other users;
e) assigning a merit rating to each registered user based on their activities on the system;
f) after a predetermined threshold is reached (e.g., a predetermined period of time has passed or upon reaching a funding goal), providing votes to the applicable users which may be used by these users to vote for other eligible users they believe should be selected to interview with the Parent Entity for the opportunity to be hired for an open job position in the Child Entity;
g) based on the number of votes for each user, selecting a subgroup of users to be interviewed by the Parent Entity;
h) interviewing and hiring the selected users to fill available positions at the Child Entity;
i) establishing the Child Entity with funding from the user donations made to the Parent Entity during the child creation period; and
j) informing the public through the web-based system the results of the Child Entity Creation Event (e.g., who was hired, the entity type of the Child Entity, start date, etc.).

These basic steps in the Child Entity creation event may be performed over and over again in perpetuity to create a series of charitable child entities although multiple concurrently running and/or staggered child creation events are also possible. The steps of creating a single Child Entity is referred to as a “child creation event” while the steps of creating more than one Child Entity (whether in serial, concurrent or staggered fashion) is referred to as a “Child Entity creation process”.

The nature/purpose of the child charity may be chosen at any desired point in time whether at the very beginning of the Child Entity creation process, once the Child Entity is established, or at any time therebetween.

It will thus be appreciated that the inventive process provides a number of advantages over existing charitable entity creation, including the following, for example:
1) Allowing users (e.g., individuals and/or groups of individuals and/or legal entities) to participate in the creation of a charity in a variety of levels including helping select the people who will help lead or direct the efforts of the charity based on the merits of their life activities demonstrated through the system;
2) Allowing users the ability to apply through the use of the web-based system for a job of leading or directing the efforts of a charitable entity;
3) Encouraging benevolence amongst the users by providing the ability for users to conduct activities and/or log their own and/or others' benevolent acts to obtain a benevolence merit rating that they can then share with others, if desired, which incentivizes users to perform more and more benevolent acts for the benefit of society;
4) Providing a system which can create in potentially perpetual fashion a multitude of fully funded, long lasting charitable entities; and
5) Encouraging donations to be made to charitable causes by allowing the users to participate in the many personally engaging activities the system offers the users (in other words, the 21^{st} century donator is not simply writing a check and walking away as was the 20^{th} century donator).

### BRIEF DESCRIPTION OF THE DRAWINGS

FIG. 1 is an organizational flow diagram in accordance with one possible embodiment of the invention;

FIG. 2 is a network flow diagram in accordance with one possible embodiment of the invention;

FIG. 3 is a system flow diagram in accordance with one possible embodiment of the invention;

FIG. 4 is a system activities flow diagram in accordance with one possible embodiment of the invention;

FIG. 5 is a donation flow diagram in accordance with one possible embodiment of the invention;

FIG. 6 is a log activities flow diagram in accordance with one possible embodiment of the invention;

FIG. 7 is a view users flow diagram in accordance with one possible embodiment of the invention;

FIG. 8 is an interact with others flow diagram in accordance with one possible embodiment of the invention;

FIG. 9 is a manage groupings flow diagram in accordance with one possible embodiment of the invention;

FIG. 10 is a review user activities flow diagram in accordance with one possible embodiment of the invention;

FIG. 11 is a user's activity flow diagram in accordance with one possible embodiment of the invention;

FIG. 12 is a verify user's activity flow diagram in accordance with one possible embodiment of the invention;

FIG. 13 is a grade user's activity flow diagram in accordance with one possible embodiment of the invention;

FIG. 14 is a send notices of encouragement flow diagram in accordance with one possible embodiment of the invention;

FIG. 15 is a designate a noteworthy contributor flow diagram in accordance with one possible embodiment of the invention;

FIG. 16 is an ask a user to be associated with them flow diagram in accordance with one possible embodiment of the invention;

FIG. 17 is an elections flow diagram in accordance with one possible embodiment of the invention;

FIG. 18 is an invite others flow diagram in accordance with an embodiment of the invention;

FIG. 19 is a selection event flow diagram in accordance with one possible embodiment of the invention; and

FIG. 20 is an entity creation flow diagram in accordance with one possible embodiment of the invention.

### DETAILED DESCRIPTION OF PREFERRED EMBODIMENTS

The process described and shown herein involves the creation of a single Child Entity called a “Child Entity Creation Event”. The process is repeatable allowing multiple Child Entities to be created in serial (sequential) fashion in perpetuity although concurrent or staggered child entity creation processes may also be implemented as desired.

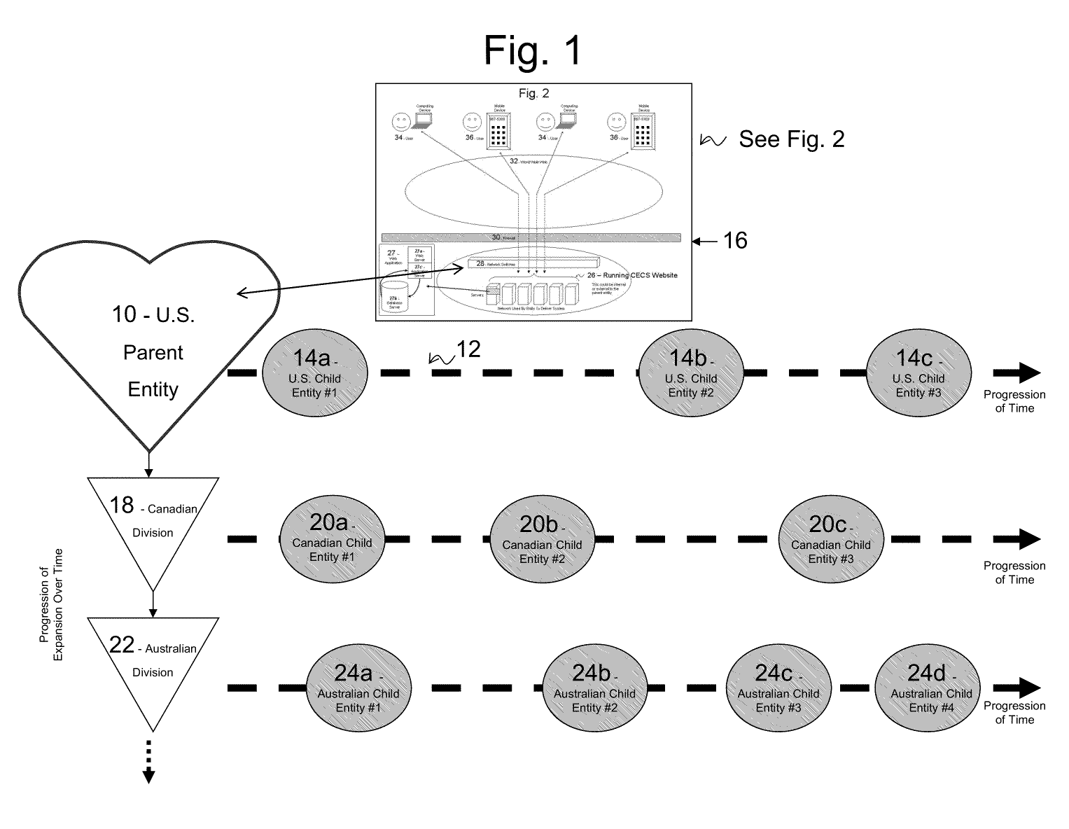

Referring now to the drawings, there is seen in FIG. 1 an exemplary embodiment of the inventive web-based system which involves the creation of charitable Child Entities. The Child Entity creation process begins with the establishment of a Parent Entity indicated by reference numeral 10. The term “establishment” or “establishing” is to be broadly interpreted and may include an already existing entity or creation of a new entity. It is envisioned that the main Parent Entity will be U.S. based as shown in FIG. 1 but non-U.S. Parent Entities are of course possible. It is further understood that the Parent Entity may manage the Child Entity creation process either by itself or by outsourcing all or part of the process to one or more other individuals, groups and/or legal entities. It is furthermore envisioned that a Child Entity may become a Parent Entity at any desired point whereby the Child Entity assumes the role of a Parent Entity in the management of the Child Entity Creation Event process.

To the right of Parent Entity 10 is a time line indicated by dashed line 12. Using the inventive process, one or more U.S. Child Entities 14a, 14b and 14c, etc. may be created in serial (sequential) fashion.

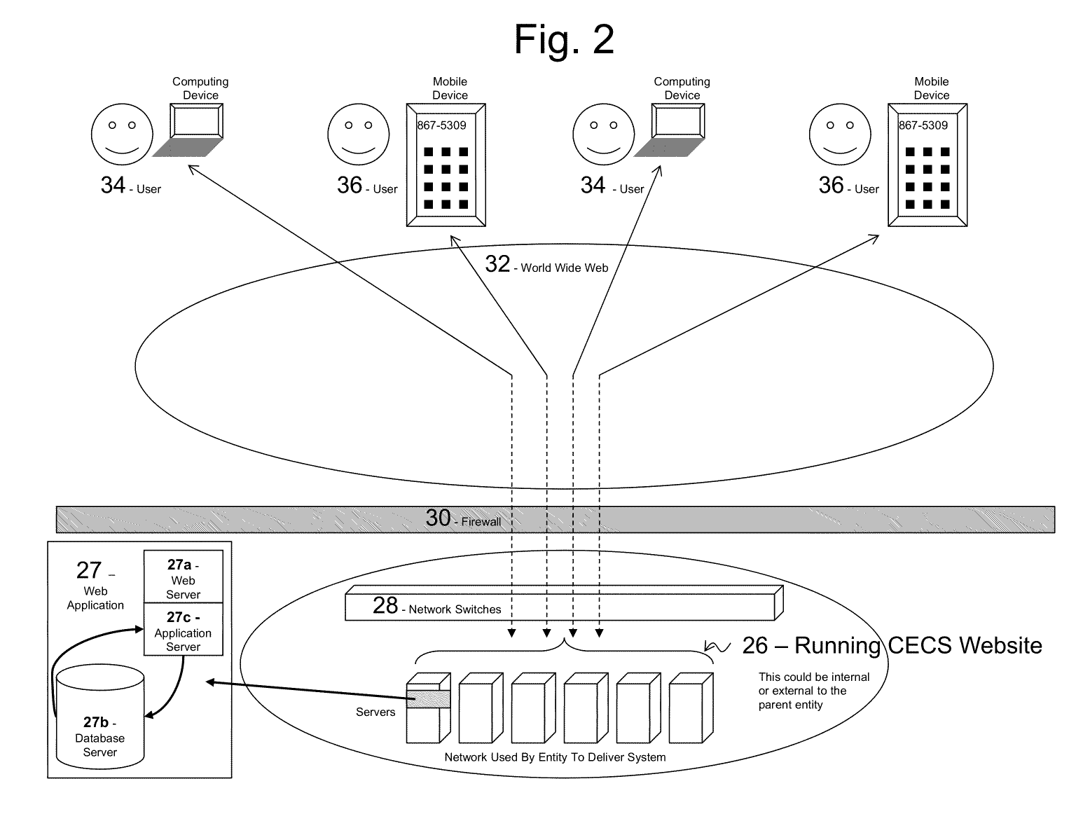

The Parent Entity 10 establishes a web-based system 16 to manage the Child Entity creation process and which will be described in more detail with reference to FIG. 2. It is understood that the term “web-based system” includes the software code (not shown) necessary to carry out the inventive process described herein. Such software code may be written by anyone skilled as a software programmer (also referred to as a “software engineer” or “coder”) to accomplish the functionality of the web-based system as described herein.

Referring still to FIG. 1, it is envisioned that non-U.S. based Parent Entities may be formed to manage the Child Entity creation process in non-U.S. countries. For example, a Parent Entity may be located in Canada as indicated at 18 and this Parent Entity may implement the inventive process to establish one or more Child Entities in Canada as indicated at 20a, 20b and 20c. Yet another Parent Entity may be established in Australia as indicated at 22 and this Parent Entity may implement the inventive process in Australia to create one more Child Entities as indicated at 24a, 24b, 24c and 24d, for example. However, it is possible that the overseas entities may be Child Entities as opposed to Parent Entities and these Child Entities can create further Child Entities in their respective country.

The legal entity type (e.g., for profit, not-for-profit, non-profit, corporation, limited liability company, partnership, foundation, trust, etc.) and legal relationship (e.g., business unit, division, subsidiary, stand-alone separate entity, etc.) between each Parent Entity and the Child Entities may vary as desired and as required according to the laws of the country in which each is located. Again, it is envisioned that the Child Entity could be part of a Parent Entity (e.g., division, work group, team, business unit, etc.).

### The System

Referring now to FIG. 2, a network flow diagram of one possible embodiment of the inventive system is shown to include one or more computer servers 26 which are used by the Parent Entity to implement the web-based system. Computer servers 26 may be physically located anywhere and be either owned or licensed for use or otherwise accessible by the Parent Entity, for example. Residing on the servers is the web-based application 27 which may be comprised of a web server 27a for presenting the content of the web-based system (the “presentation layer”) and allowing input from the user to be exchanged with the system and stored or retrieved from the database server 27b (the “data storage layer”), as well as an application server 27c for the handling of the business logic that will direct the functionality of the system (the “business logic layer”). One or more network switches 28 and one or more firewalls 30 may be included in the network architecture as desired or required. Although not shown, it is understood that the web-based system may include additional hardware, software and electronic connections as deemed necessary or desirable as is well understood by those skilled in the art of web design and the functionality derived from web application development, including the architecture and functionality of interactive internet computer systems.

The Parent Entity establishes a web-based system presenting a website that runs on servers 26 which the public (users) may access via the world wide web 32 using any suitable electronic connecting device, common examples of which include a desktop/laptop/notebook computing device 34 and a hand-held mobile device 36.

The core of the inventive system includes the computer code (not shown) that enables the functionality of the system and resides on the computer hardware (e.g., the servers) and allows the users to interact with the system through the capabilities of the network (such as the world wide web).

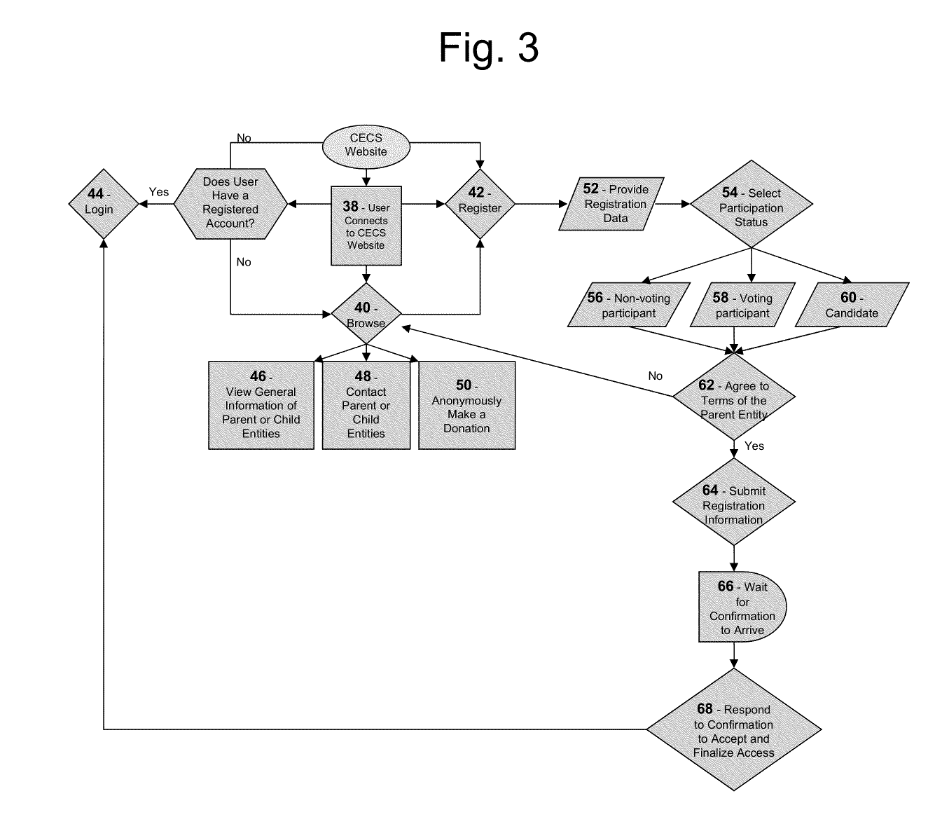

Referring to FIG. 3, when a user accesses the CECS website at 38, they have essentially three options: browse at 40, register at 42 or login at 44 (once they complete their registration). When users browse the website, they can view the information that is publicly available at 46, and/or contact the Parent or Child Entities at 48, and/or anonymously make a donation at 50 for the creation of the Child Entity being highlighted at that time. The website may highlight to everyone visiting the publically facing main website page the current donation level and the Child Entity for which the donations are being accepted.

If a user wants to do more than browse and/or contact and/or donate, they have the ability to register to gain access to the part of the CECS website that allows the user to actively participate in the many user activities described in more detail below. The registration process consists of the user entering data pertinent to the registration process at 52 (e.g., first name, middle name, last name, suffix, date of birth, email address, phone number, password, etc.). It should be noted that only registered users will be able to log into and authenticate to the password protected area of the web-based system. The user will then be asked at 54 to designate their participation status as either Non-voting participant at 56, voting-participant at 58 or candidate at 60. It is understood that other categories of participation status may be used (e.g., read-only participant, etc.). The following is a definition that distinguishes between the three options:

1.) A non-voting participant status means the user can access the system designated for user activities just as any other user. The non-voting participant user will be able to log their activities and build their own profile, however, the non-voting participant status disqualifies a user from participating in the election process in any manner. A non-voting participant can use the system in one or more ways with the exception being that they cannot participate in the election process (e.g. voting for candidates or be a candidate themselves and run in the election) as will be explained further below.

2.) A voting-participant status means the user can access the system designated for all the user activities with the exception that the voting-participant user will not be eligible to participate as a candidate in the election to help lead or direct the efforts of the Child Entity although they do have full voting rights in the election process.

Both non-voting and voting participants or all users can either use their real name or identify themselves to other users with a unique, custom system name or first names could be used with a combination of nicknames.

3.) A candidate status means the candidate user can access the system designated for all the user activities, has full voting rights, and furthermore is eligible to take part in the election to help lead or direct the efforts of the Child Entity.

After selecting a participation status, a user is asked at 62 to accept the terms of the Parent Entity. These terms may outline, among other things, the conditions of eligibility for participating in the election for the opportunity to interview with the Parent Entity. The interview process and vetting process of the top number of users from the election will require certain conditions to be met in order to be considered for the hiring into the Child Entity's available job positions. Any false information in the registration process is a condition to be disqualified, as is any activity that is claimed to be verified by the user and turns out to be proven false during the vetting process. Other conditions detrimental to the brand of the Parent Entity will also be potential for disqualification. Any user that does not agree to these terms cannot register onto the system and will remain an unregistered user that can only browse the system at 40 without logging into the system.

After the terms and conditions are agreed to, the user will submit their registration information at 64 and a confirmation communication at 66 (e.g. email or text) will be forwarded to the location they indicated in their registration process. When the user receives the confirmation communication they will be able to respond at 68 which would accept and finalize their ability to log into the system at 44. When a user is able to successfully log into the system, they will have the ability to take part in the activities the system makes available to registered users. It should be noted that registered users may select which components of their information will be public or private to other registered users (e.g., profile).

### Activities on the System

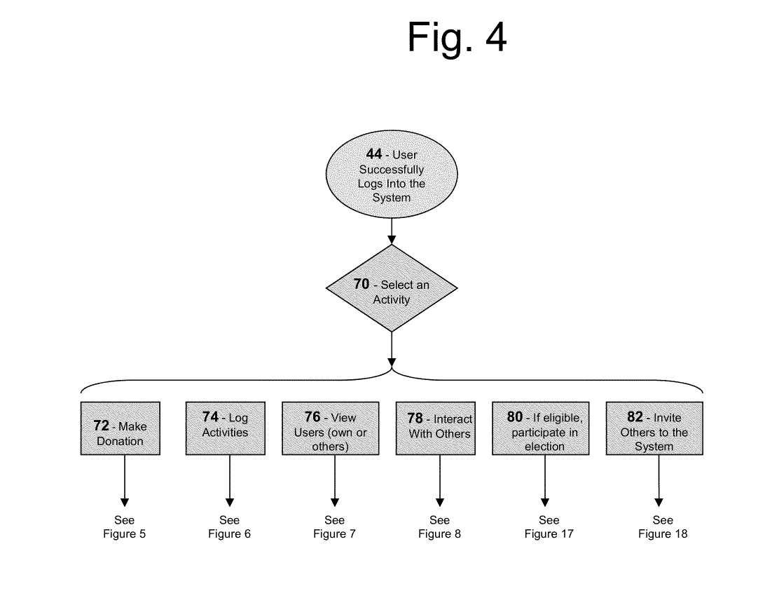

Referring to FIG. 4, once a user has logged into the system, they can select an activity at 70 which may include, for example, one or more of the following activities: make a donation at 72, log the user's activities at 74, view other users at 76, interact with other users at 78, participate in elections (if eligible) at 80, and invite others to join the system at 82.

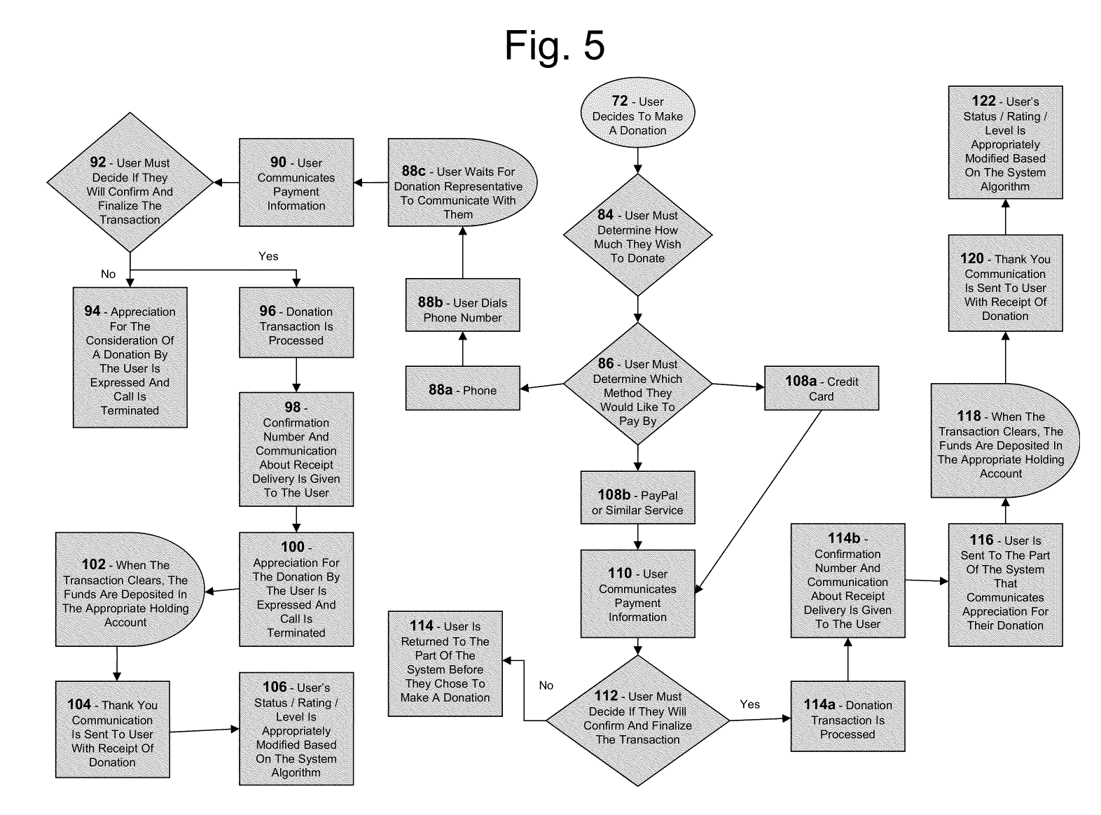

Referring to FIG. 5, the user decides they wish to make a donation at 72. The user will then need to indicate how much they will choose to donate at 84 and which payment method they would prefer at 86. If a user wants to talk with a person to make the donation, they can call a specific donation dedicated phone number and speak directly to a representative at 88a-c. The representative will take their financial information that will support the transaction at 90. However, before executing the transaction the representative will ask if the user is sure they want to confirm the donation at 92. If the user decides to back out of the transaction then the representative expresses their appreciation for the consideration of a donation by the user and the call is terminated at 94. Otherwise, the donation transaction is processed at 96 and a confirmation number and communication about the receipt delivery is given to the user at 98. Appreciation for the consideration of a donation by the user is expressed and the call is terminated at 100. In time, when the transaction clears, the donation funds are deposited into the Parent Entity owned holding account at 102. A thank you communication is sent to the user with the receipt of donation at 104. The user's status/rating/level is appropriately modified based on a system-based algorithm (to be discussed further below) at 106.

If a credit card at 108a or Paypal or some other payment service at 108b is chosen by the user, then the user will communicate the appropriate financial information within the system at 110. After the required information has been entered, the user will be asked if they are sure they want to confirm the donation at 112. If the user decides to back out of the transaction then the system expresses appreciation for the consideration of a donation by the user and the system sends the user to the part of the system where the user was before they chose to make a donation at 114. If the user confirms they want to make a donation, then the donation transaction is processed at 114a and a confirmation number and communication about the receipt delivery is given to the user at 114b. The user is then sent to the part of the system where the user was before they chose to make a donation at 116. In time, when the transaction clears, the donation funds are deposited into the parent entity owned holding account at 118. A thank you communication is sent to the user with the receipt of donation at 120. The user's status/rating/level is appropriately modified based on the system's algorithm at 122. Any desired algorithm may be created to calculate a user's status/rating/level using one or more of the following criteria, for example:
Days active on the web-based system
Elections participated in
Elections eligible to but not participated in
Original Donor (Y or N)
Donation Level
Cumulative Donation Level
Number of Verifiable Benevolent Activities per Child Entity Creation Event
Number of Unverifiable Benevolent Activities per Child Entity Creation Event
Number of ratings received per Verifiable Benevolent Activities per Child Entity Creation Event
Number of ratings received per Unverifiable Benevolent Activities per Child Entity Creation Event
Number of ratings given to other user's Verifiable Benevolent Activities per Child Entity Creation Event
Number of ratings given to other user's Unverifiable Benevolent Activities per Child Entity Creation Event
Average rating given to other user's Verifiable Benevolent Activities per Child Entity Creation Event
Average rating given to other user's Unverifiable Benevolent Activities per Child Entity Creation Event
Number of correct flags placed on other user's Verifiable Benevolent Activities that were determined to be false during the interview process
Number of incorrect flags placed on other user's Verifiable Benevolent Activities that were determined to be true during the interview process
Number of comments placed on other user's Benevolent Activities per Child Entity Creation Event
Number of responses accepted from other users for being a noteworthy Benevolent Contributor
Number of noteworthy Benevolent Contributor notifications received by a user

It is desirable to keep the system algorithm itself embedded within or otherwise accessible by the system software and inaccessible to a user as this will help deter users from “gaming the system”. That is to say, if users knew exactly how status/rating/level was calculated, they could attempt to negatively affect other user's status/rating/level or artificially enhance their own rating.

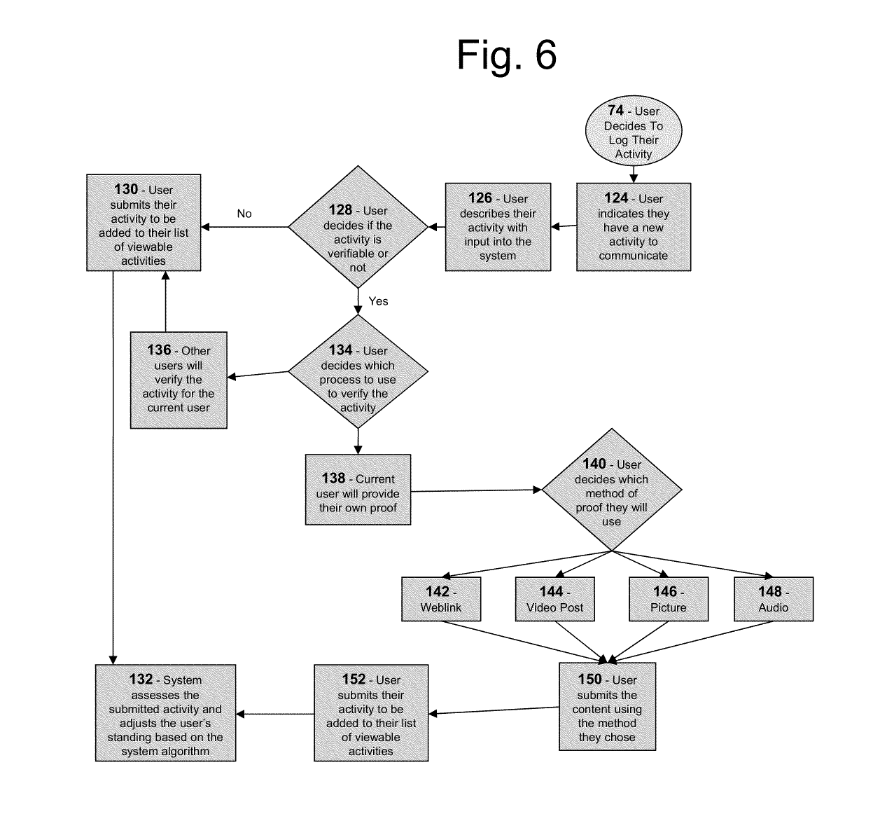

Referring now to FIG. 6, the user will decide they want to log an activity (e.g., a benevolent act) they are making in the system at 74 and will go to that place in the system to accomplish this objective. The user will indicate that they have a new activity to log at 124 and they will provide a description of the activity within the system at 126 for other users to read. The user will need to decide if the activity is verifiable or not at 128 (verifiable activities are viewed by the system via the algorithm in higher standing than non-verifiable activities). If the activity is not verifiable (e.g., there were no eyewitnesses or supporting content to the benevolent act), then the user will submit their activity at 130 and it will be added to their list of viewable activities for other users to see and contribute to by engaging in the system activity of interacting with others at 78. Also, the system will assess the newly submitted activity and adjust the user's standing based on the algorithm within the system at 132.

If the activity is verifiable, then the user will decide which process they want to use to verify the activity at 134. If the user decides that other users will verify the activity for the current user at 136, then the current user will submit their activity and it will be added to their list of viewable activities at 138 for other users to see and contribute to. Also, the system will assess the newly submitted activity and adjust the user's standing based on the algorithm within the system at 132.

If the user decides that they will provide their own proof of the activity at 138, then they will choose which method of proof they will use at 140. For example, one or more methods of proof may be provided: weblink at 142, video post at 144, pictures at 146, and audio at 148, although it is understood other methods may be provided by the system as desired.

After the user selects their method of proof, they will submit their content of proof using the chosen method at 150. The current user will then submit their activity at 152 and it will be added to their list of viewable activities for other users to see and contribute to. Also, the system will assess the newly submitted activity and adjust the user's standing based on the algorithm within the system at 132.

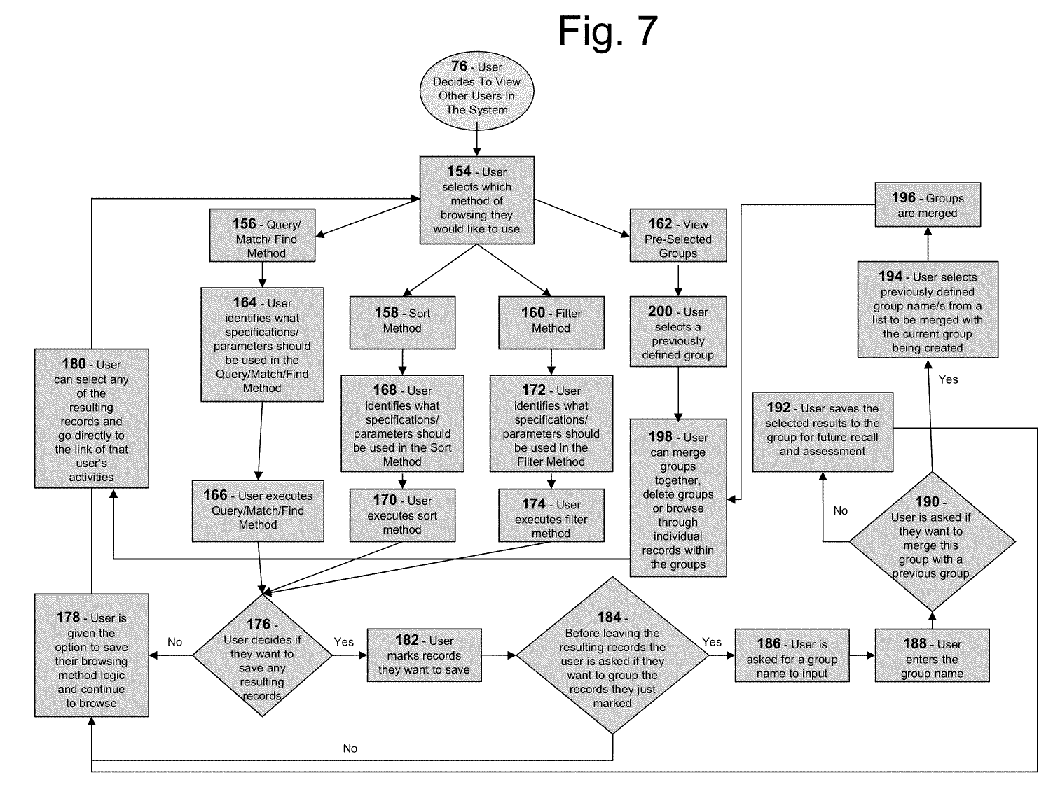

Referring now to FIG. 7, the user will decide to use the system to view other users at 76 and their corresponding activities. The user can select the method of browsing they would like to use at 154, examples of which include query/match/find method at 156, sorting at 158, filtering at 160, and looking at predefined groupings at 162. If the user selects the query/match/find method at 156, they will use the system to select which specifications or parameters that should be used in the method at 164 and the system will build the backend logic (e.g., Structured Query Language SQL) to return the corresponding records of users when the user executes the method at 166.

If the user selects the sort method at 158, they will use the system to select which specifications or parameters that should be used in the method at 168 and the system will build the backend logic (e.g., Structured Query Language SQL) to return the corresponding records of users when the user executes the method at 170.

If the user selects the filter method at 160, they will use the system to select which specifications or parameters that should be used in the method at 172 and the system will build the backend logic (e.g., Structured Query Language SQL) to return the corresponding records of users when the user executes the method at 174.

The system will ask the user if they would like to save any of the resulting records returned from the query/match/find, sort or filter methods at 176.

If the user does not want to save any records, then the user is given the option to save their browsing method logic and continue to browse for more users at 178. The user can also select any of the resulting records and go directly to the link of that user's activities at 180 to obtain a better perspective of that user's qualifications for when the voting time of an election comes or to interact with that user.

If the user does wish to save some records from the result set, then the user must mark the records they want to save at 182. Before leaving the resulting records the user is asked if they want to group the records they just marked at 184. If the user does not, then the user is given the option to save their browsing method logic and continue to browse for more users at 178. The user can also select any of the resulting records and go directly to the link of that user's activities at 180 to obtain a better perspective of that user's qualifications for when the voting time of an election comes or to interact with that user.

If the user does want to group the marked records, then the system asks the user to input a name for the group at 186 and the user provides a name at 188. The system then asks the user if they want to merge the new group with an already existing group or groups at 190. If the user does not want to merge any groups, then the user saves the selected results to the group for future recall and assessment at 192 and then is given the option to save their browsing method logic and continue to browse for more users at 178. The user can also select any of the resulting records and go directly to the link of that user's activities at 180 to obtain a better perspective of that user's qualifications for when the voting time comes of an election or to interact with that user.

If the user does want to merge the newly created group with any predefined groups, then the user can select previously defined group name(s) from a list to be merged with the current group being created at 194 and the system will perform the merge at 196. The user can then merge other groups together, delete groups or browse through individual records within any groups they select or make further selections from the records in the group they have chosen at 198. The user can also select any of the resulting records and go directly to the link of that user's activities to obtain a better perspective of that user's qualifications for when the voting time of an election comes or to interact with that user at 180.

If a user decides to view predefined groups, then the user must select within the system which predefined groups they want to browse from a list at 200. The user can then merge other groups together, delete groups or browse through individual records within any groups they select or make further selections from the records in the group they have chosen at 198. The user can also select any of the resulting records and go directly to the link of that user's activities to obtain a better perspective of that user's qualifications for when the voting time of an election comes or to interact with that user at 180.

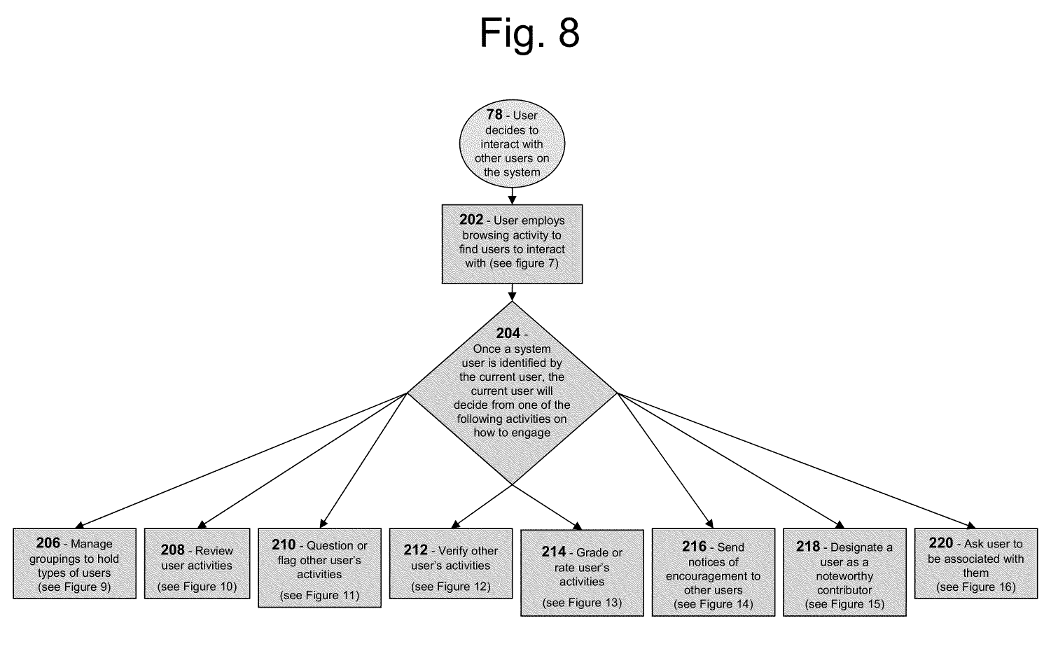

Referring now to FIG. 8, the user may decide to interact with other users on the system at 78. The user would employ the browsing activity identified in FIG. 7 to find users to interact with at 202. Once a system user is identified by the current user, the current user will decide at 204 from one of the following activities on how to engage with the registered system user: manage folders to hold types of users at 206, review user activities at 208, question or flag other user's activities at 210, verify other user's activities at 212, grade or rate user's activities at 214, send notices of encouragement to other users at 216, designate a user as a noteworthy contributor at 218, and ask a user to be associated with them at 220.

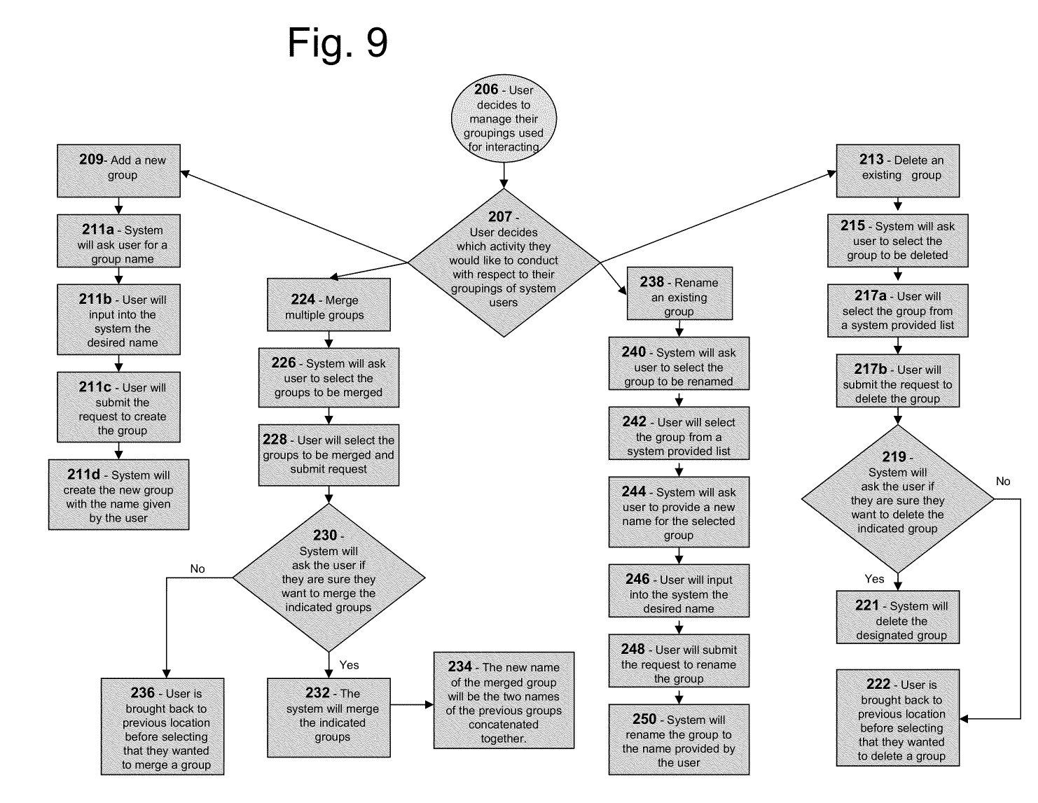

Referring now to FIG. 9, a user decides to manage their groupings used for interacting with other system users at 206 and decides which activity they would like to conduct with respect to their groupings of system users at 207. The groupings are containers of lists of other system users that the current user feels should be categorized in some way that they feel is important to them. For example, a user could create the following hypothetical groupings: Must Vote For, Questionable Activities Group, Inspirational Group. The user would then assign the system users they feel fit best in a respective grouping. This will allow a user to easily retrieve or navigate to a specific system user's list of activities or profile.

A user can add a new grouping by indicating they want to do so. They will then be prompted for a name to call the grouping and then they will submit the request to add the new group at 209. The system will then create the new group with the name given by the user at 211a-d.

A user can delete an existing grouping by indicating they want to do so at 213. They will then be prompted to select the grouping they want deleted at 215. The user will then submit their request to delete the group at 217a-b. The system will ask if they are sure they want to delete the group at 219 and, if so, they will then submit the request to delete the group. The system will then delete the group designated by the user at 221. If no, the user is brought back to the previous location before selecting they wanted to delete a group at 222.

A user may also want to merge multiple groups by indicating that they want to do this activity at 224. The system will ask the user to select the groups to be merged at 226. The user will have a list of groups where they can select the groups to be merged and then they will submit the merge request at 228. The system will ask the user if they are sure they want to merge the indicated groups at 230. If the user indicates that they do want to merge the groups, then the system will merge the groups at 232. The new name of the merged group will be the two names of the previous groups concatenated together at 234. Otherwise, the user is brought back to previous location before selecting that they wanted to merge groups at 236.

A user may also want to rename a group by indicating that they want to do this activity at 238. The system will ask the user to select the group they want to be renamed at 240 and the user will select the group from a system provided list of groups belonging to the user at 242. The system will then ask the user to provide a new name for the selected group at 244 and the user will input into the system the new requested name for the group at 246. The user will then submit the request to rename the group at 248 and the system will rename the group to the name provided by the user at 250.

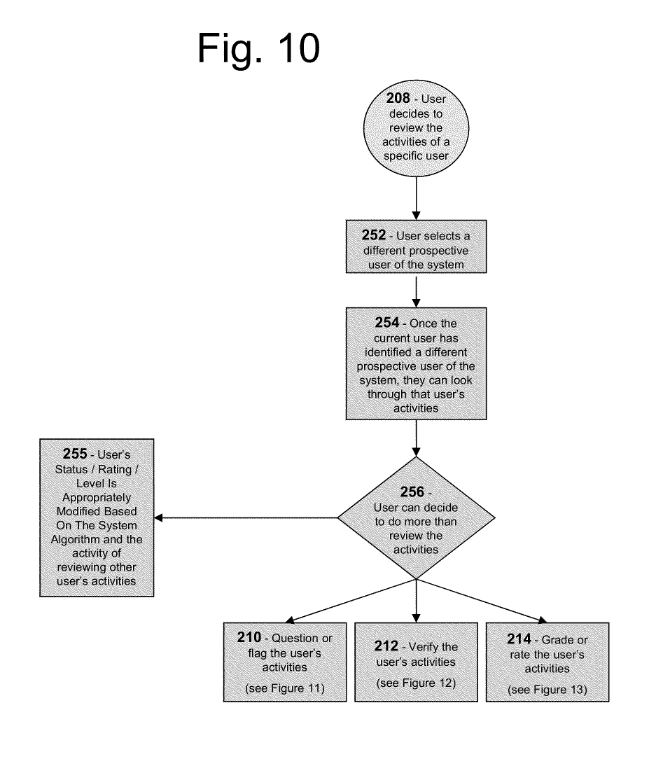

Referring now to FIG. 10, a user could decide to review the activities of a specific user at 208. The user will then select a different prospective user of the system at 252. Once the current user has identified a different prospective user of the system, they can look through that user's activities at 254. The user can then decide to do more than just review the activities at 256. For example, they can also question or flag the user's activities at 210, verify the user's activities at 212 and/or grade or rate the user's activities at 214. A user's status/rating/level is appropriately modified based on the system's algorithm and the activity of reviewing other user's activities at 255.

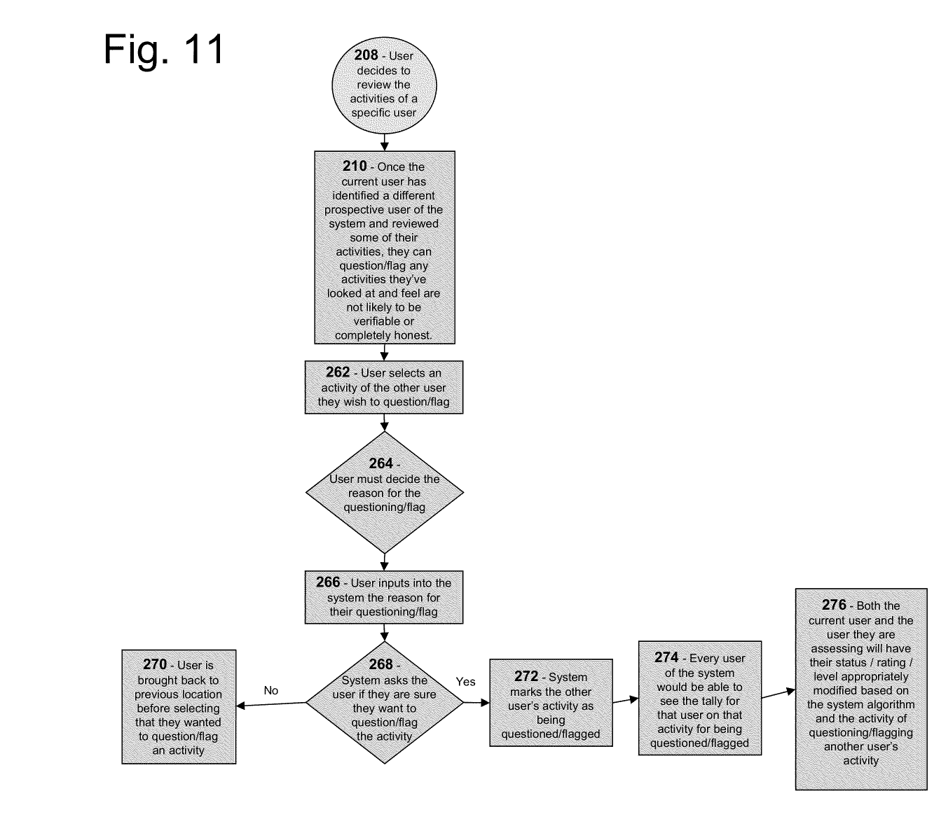

Referring now to FIG. 11, a user could decide to question or flag the activities of a specific user beginning at 208. Once the current user has identified a different prospective user of the system and reviewed some of their activities, they can question any activities they've looked at and feel are not likely to be verifiable or completely honest at 210. The user would select an activity of the other user they wish to question/flag at 262 and decide the reasoning for why they would want to question/flag the activity at 264. The user would then input into the system the reason for their questioning/flagging of the activity at 266. The system would ask the user if they were sure they wanted to question/flag the activity at 268 and, if not, then the user would be brought back to their previous location before selecting that they wanted to question/flag an activity at 270. Otherwise, the system may mark the other user's activity as being questioned/flagged at 272 and every user of the system may be able to see the tally for that user on that activity for being questioned/flagged at 274. Both the current user and the user they are assessing will have their status/rating/level appropriately modified based on the system's algorithm and the activity of questioning/flagging another user's activities at 276.

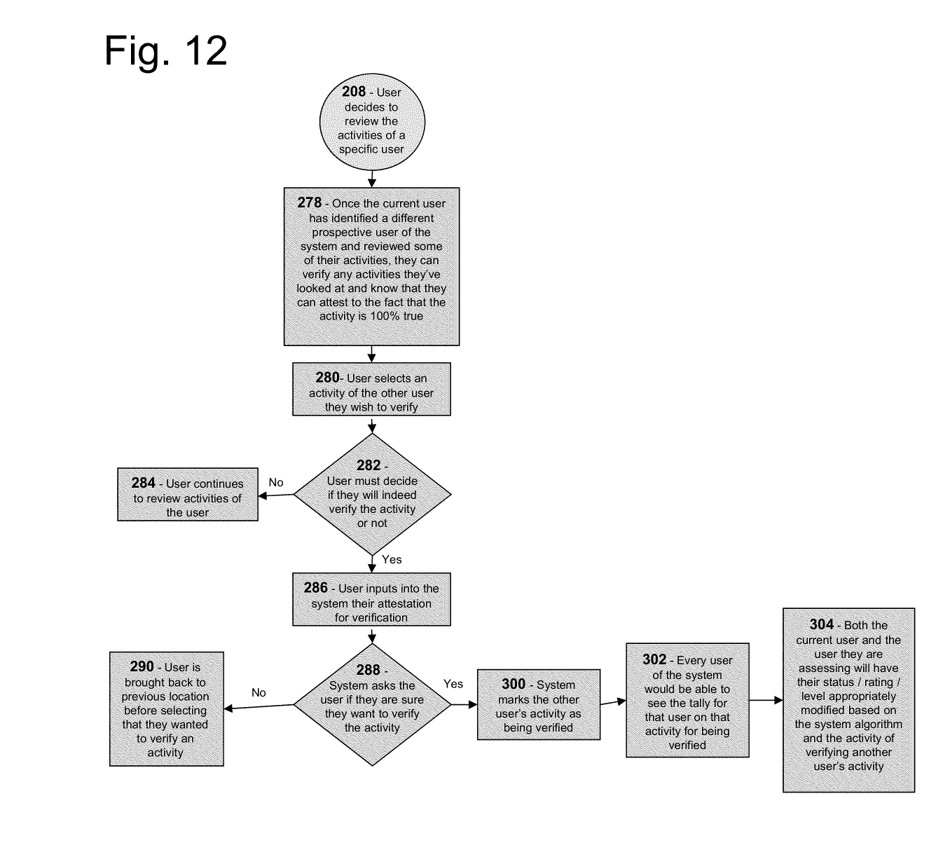

Referring now to FIG. 12, a user could decide to verify the activities of a specific user at 208. Once the current user has identified a different prospective user of the system and reviewed some of their activities, they can verify any activities they've looked at and know that they can attest to the fact that the activity is 100% true at 278. The user would select an activity of the other user that they wish to verify at 280. The user must then decide if they will indeed want to verify the activity or not at 282. If they change their mind, they can simply continue to review other activities of the user at 284. Otherwise, the user will input into the system their attestation for verification of the activity at 286. This attestation is an activity by the user that they are 100% certain the other user's activity is true because they have first-hand knowledge of the activity being true. The system would ask the user if they were sure they wanted to verify the activity at 288 and, if not, then the user would be brought back to previous location before selecting that they wanted to verify an activity at 290. Otherwise, the system may mark the other user's activity as being verified at 300 and every user of the system may be able to see the tally for that user on that activity for being verified at 302. Both the current user and the user they are assessing will have their status/rating/level appropriately modified based on the system's algorithm and the activity of verifying another user's activities at 304.

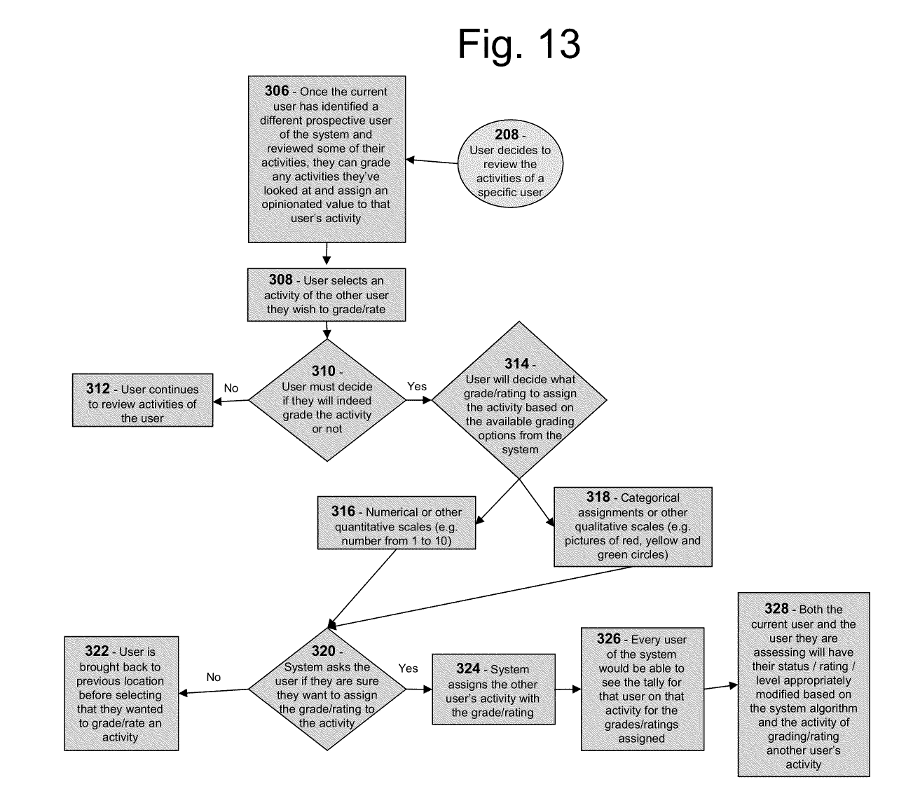

Referring now to FIG. 13, a user could decide to grade/rate the activities of a specific user at 208. Once the current user has identified a different prospective user of the system and reviewed some of their activities, they can grade any activities they've looked at and assign an opinionated value to that user's activity at 306. The user selects an activity of the other user they wish to grade/rate at 308. The user must then decide if they will indeed grade/rate the activity or not at 310 and, if not, they can continue to review activities of the user at 312. Otherwise, the user will decide what grade/rating to assign the activity based on the available grading/rating options from the system at 314, for example, numerical or other quantitative scales at 316 and categorical assignments or other qualitative scales at 318.

The system would ask the user if they were sure they wanted to assign the grade/rating to the activity at 320 and, if not, the user would then be brought back to their previous location before selecting that they wanted to grade/rate an activity at 322. Otherwise, the system may assign the other user's activity with the grade/rating provided by the user at 324 and every user of the system may be able to see the tally for that user on that activity for the grades/ratings assigned at 326. Both the current user and the user they are assessing will have their status/rating/level appropriately modified based on the system's algorithm and the activity of grading/rating another user's activities at 328.

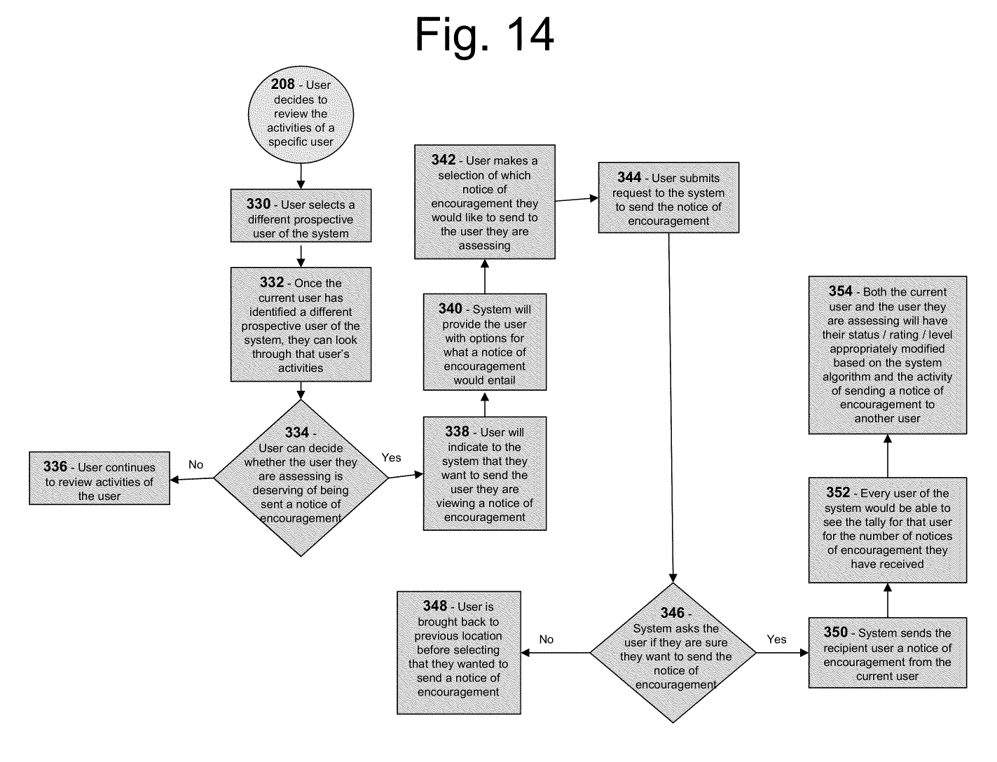

Referring now to FIG. 14, a user could decide to review the activities of a specific user at 208. The user will then select a different prospective user of the system at 330. Once the current user has identified a different prospective user of the system, they can look through that user's activities at 332. The user can decide whether the user they are assessing is deserving of being sent a notice of encouragement at 334 and, if they choose they are not deserving, then the user can continue to review the activities of the user being assessed at 336. Otherwise, the user will indicate to the system that they want to send the user they are viewing a notice of encouragement at 338 and the system will provide the user with options for what a notice of encouragement would entail at 340. The user would then make a selection of which notice of encouragement they would like to send to the user they are assessing at 342 and then submit a request to the system to send the notice of encouragement at 344. The system would then ask the user if they were sure they wanted to send the notice of encouragement at 346 and, if not, the user would then be brought back to their previous location before selecting that they wanted to send a notice of encouragement at 348. Otherwise, the system may send the recipient user a notice of encouragement from the current user at 350. Every user of the system may be able to see the tally for that user for the number of notices of encouragement they have received at 352. Both the current user and the user they are assessing will have their status/rating/level appropriately modified based on the system's algorithm and the activity of sending a notice of encouragement to another user at 354.

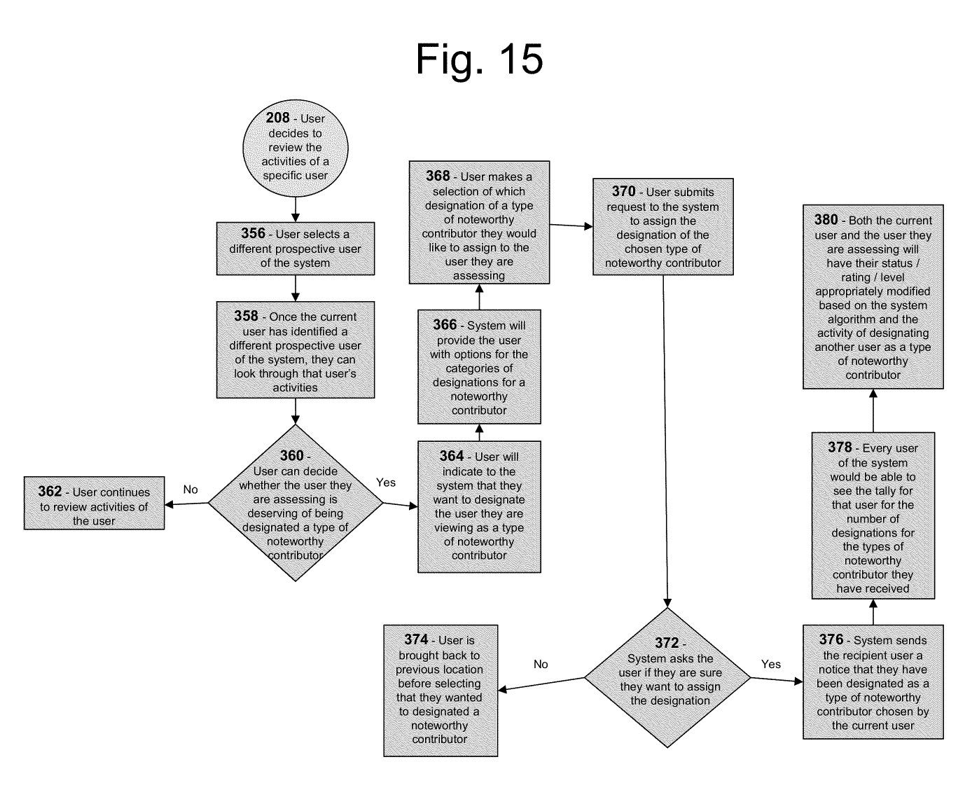

Referring now to FIG. 15, a user could decide to review the activities of a specific user at 208. The user will select a different prospective user of the system at 356. Once the current user has identified a different prospective user of the system, they can look through that user's activities at 358. The user can then decide whether the user they are assessing is deserving of being designated a type of noteworthy contributor at 360 and, if they choose they are not deserving, then the user can continue to review the activities of the user being assessed at 362. Otherwise, the user will indicate to the system that they want to designate the user they are viewing as a type of noteworthy contributor at 364 and the system will provide the user with options for what the categories of designations for a noteworthy contributor would be at 366. The user would then make a selection of which designation of a type of noteworthy contributor they would like to assign to the user they are assessing at 368 and then submit a request to the system to assign the designation of the chosen type of noteworthy contributor at 370.

The system would then ask the user if they were sure they wanted to assign the chosen designation at 372 and, if not, then the user would be brought back to previous location before selecting that they wanted to designate a noteworthy contributor at 374. Otherwise, the system would send the recipient user a notice that they have been designated as a type of noteworthy contributor chosen by the current user at 376. Every user of the system may be able to see the tally for that user for the number of notices of encouragement they have received at 378. Both the current user and the user they are assessing will have their status/rating/level appropriately modified based on the system's algorithm and the activity of designating another user as a type of noteworthy contributor at 380.

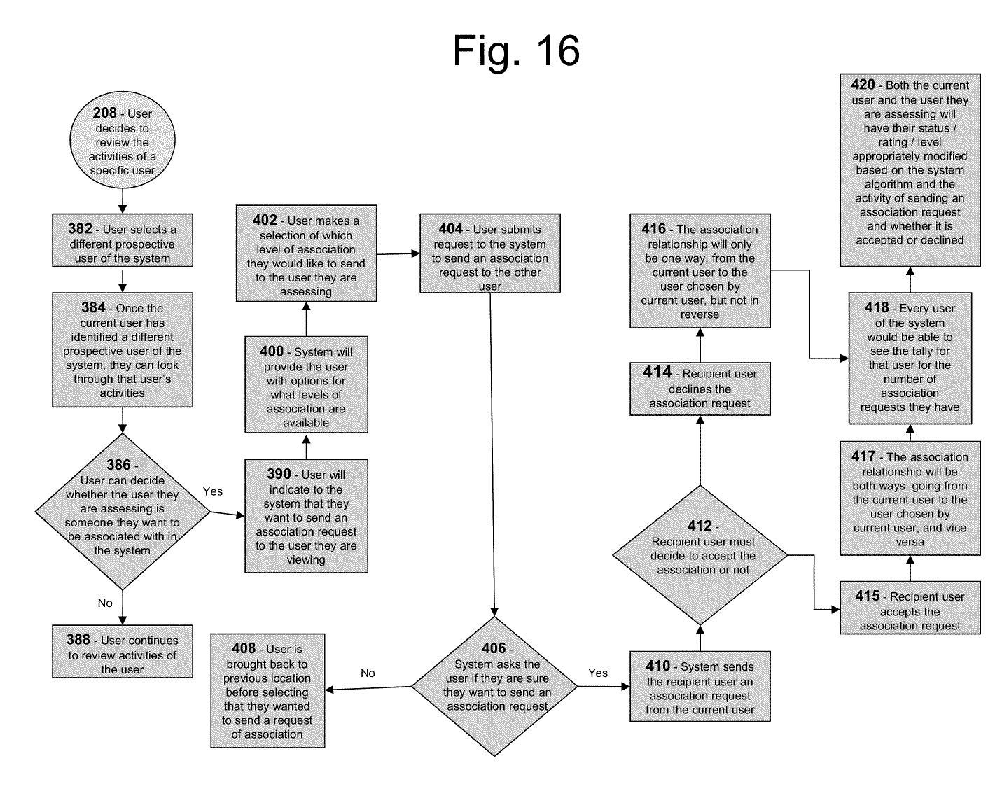

Referring now to FIG. 16, a user could decide to review the activities of a specific user at 208. The user will select a different prospective user of the system at 382. Once the current user has identified a different prospective user of the system, they can look through that user's activities at 384. The user can decide whether the user they are assessing is someone they want to be associated with within the system at 386 and, if they choose they are not someone they want to make an association with, then the user can continue to review the activities of the user being assessed at 388. Otherwise, when a user wants to ask a different user of the system if they want to be associated together, they will indicate this to the system at 390. The system will then provide the user with options for what levels of association are available at 400 and the user will make a selection for which level of association they would like to send to the user they are assessing at 402. The user will then submit a request to the system to send an association request to the other user at 404 and the system will ask the user if they are sure they want to send an association request at 406. If the user changes their mind and does not want to send the request, then they are brought back to previous location before selecting that they wanted to send a request of association at 408. Otherwise the system sends the recipient user an association request from the current user at 410.

If the recipient user does not want to accept the association request at 412 and 414, the association relationship will only be one way, from the current user to the user chosen by the current user, but not in reverse at 416. If the recipient user does want to accept the association request at 412 and 415, then the association relationship will be both ways, going from the current user to the user chosen by the current user, and vice versa at 417.

Every user of the system may be able to see the tally for that user for the number of association requests they have at 418, as the system would increment one for every association request sent and accepted by a user. Also, both the current user and the user they are assessing will have their status/rating/level appropriately modified based on the system algorithm and the activity of sending an association request and whether it is accepted or declined at 420.

### The Election

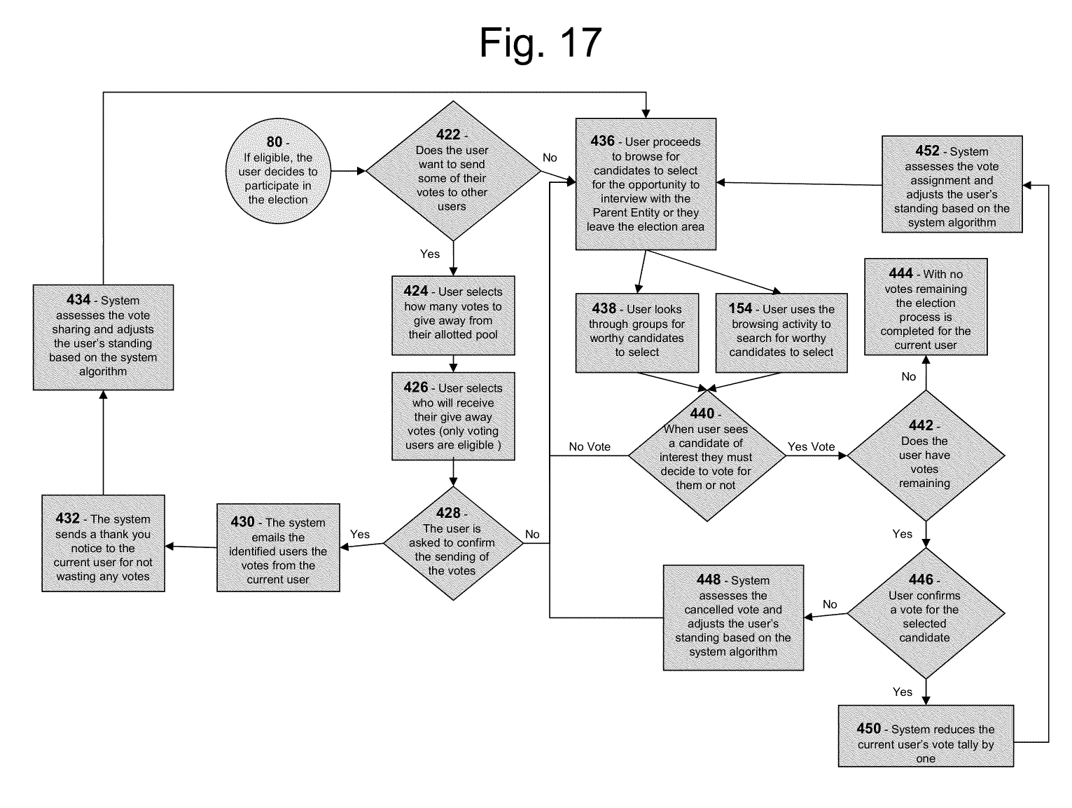

Referring now to FIG. 17, if a user is eligible, the user may decide to participate in the election at 80. The main page of the website may advertise the current purpose for an election (e.g., to apply of a job opening at the Child Entity). The system could also email or otherwise notify users reminders of election periods. Voting in the elections is not limited to just a one vote per person type of scenario (e.g., rankings could be used, etc.). If a user wants to send some of their votes to different users at 422, then they select how many votes to give away from their allotted pool at 424 and who they would like to send the votes to at 426 (only voting users would be eligible to receive votes from other users).

The user is then asked to confirm the sending of the votes at 428 and, if they do agree, the system emails the identified users the votes from the current user at 430. The system will also send a thank you notice to the current user for not wasting any votes at 432. The system will assess the vote sharing and adjusts the user's standing based on the system algorithm at 434. Users can still proceed to browse for candidates to select for the opportunity to interview with the Parent Entity or they may also leave the election area at 436. When browsing, the user can look through groups for worthy candidates to select at 438 or they can use the browsing activity at 154 (FIG. 7) to search for worthy candidates to select. When a user sees a candidate of interest they must decide to vote for them or not at 440. If they do not want to vote for the selected candidate, then the user can proceed to browse for other candidates to vote for at 436. If the user does want to vote for the selected candidate, then the system must check to see if the user has any votes remaining at 442. If the user has no votes remaining, then they are finished with the election process at 444 until the next election occurs which would reset their vote count to a positive value.

If the user does have votes remaining, they will confirm to the system they want to vote for that selected candidate at 446, otherwise they will cancel their vote and the system would adjust the user's standing based on the system algorithm at 448. The user would go back to browsing for candidates to vote for or leave the election activity at 436.

When a user has confirmed that they want to vote for a selected candidate, the system reduces the current user's vote tally by one at 450 and assigns a vote to the selected candidate. The system would then assess the vote assignment and adjust the user's standing based on the system algorithm at 452. The selected candidate's standing/ranking/level would also be assessed based on receiving a vote to interview with the Parent Entity from a different user. Afterwards, a user is always able to go back to browsing for candidates to vote for or leave the election activity at 436.

It is noted that there can be one or more than one (e.g., multiple rounds/iterations) of an election process (FIG. 17) to reduce the number of candidates to a manageable size until the final round or iteration where the selected group of the top users from the election will be given the opportunity to be vetted by the Parent Entity for the available positions in the Child Entity.

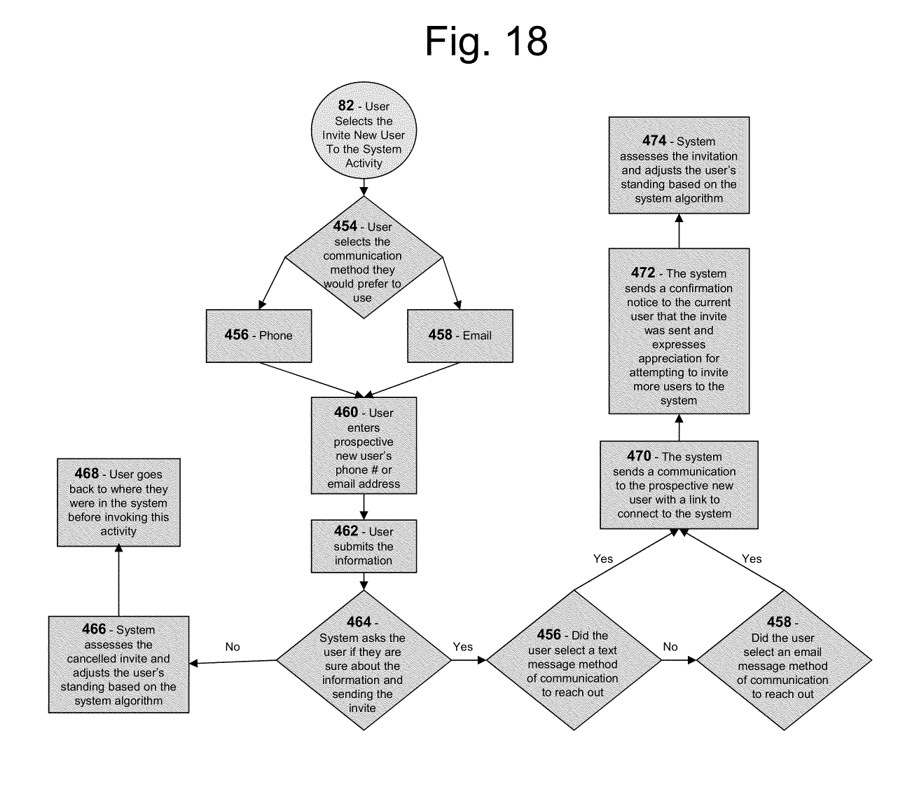

Referring now to FIG. 18, a user would select the invite new user to the system activity at 82 when they want to send an invitation to the system to someone not currently registered to use the system. The user would select the communication method they would prefer to use at 454 which could be, but is not limited to, phone at 456 or email at 458. The user would enter the prospective new user's name, phone # or email address at 460 and submit the information to the system at 462. The system then asks the user if they are sure about the information they entered and whether they are sure they want to send the invite at 464. If the user changes their mind and does not want to send the invite, then the system assesses the cancelled invite and adjusts the user's standing based on the system algorithm at 466. Then the user will go back to where they were in the system before invoking this invitation activity at 468. Otherwise, if the user is sure about the information they entered and confirms they want to send the invitation, then the system will send a communication (either through a phone text message or email, based on what was previously selected by the user at 456 or 458) to the prospective new user at 470 with a link to connect to the system. The system then sends a confirmation notice to the current user that the invite was sent and expresses appreciation for attempting to invite more users to the system at 472. The system then assesses the invitation and adjusts the user's standing based on the system algorithm at 474. The new invited user can join the system if they select the link to the system in the communication they received and then may follow the registration process.

### The Selection

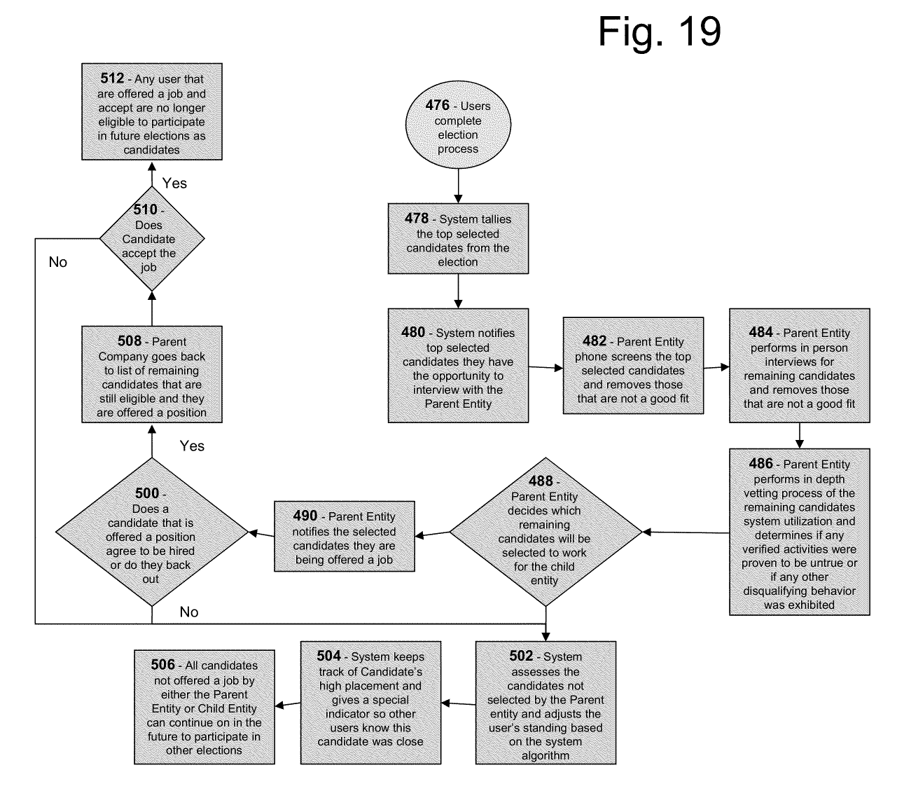

Referring now to FIG. 19, once all votes have been cast at 476, the system tallies the votes and identifies a predetermined number of candidates having the highest number of votes from the election at 478. If no other rounds/iterations will occur, the system notifies the identified top candidates (e.g., through an email communication) that they have the opportunity to interview with the Parent Entity at 480. The Parent Entity may phone screen the top selected candidates and remove those that the Parent Entity believes are not appropriate for the available job openings of leading or directing the activities of the Child Entity at 482. The Parent Entity then performs in person interviews for the remaining candidates and removes those that are not a good fit at 484. The Parent Entity then performs an in-depth vetting process of the remaining candidates by reviewing their respective system utilization including their respective merit rating and determines if any verified activities were proven to be untrue or if any other disqualifying behavior was exhibited at 486.

The Parent Entity must then decide which remaining candidates will be selected to work towards supporting the Child Entity at 488. If a candidate is not selected by the Parent entity, then the system adjusts the user's standing based on the system algorithm. The system keeps track of a candidate's high placement and gives a special indicator so that other users know this candidate was close to being chosen. This indicator can be helpful to the candidate in the next election. All candidates not offered a job by either the Parent Entity or Child Entity can continue on in the future to participate in other elections.

If a candidate is selected by the Parent Entity, then the Parent Entity notifies the selected candidates they are being offered a job at 490. If a candidate that is offered a position cannot agree to be hired or they back out at 500, then this candidate will follow the flow diagram of a candidate that is not selected by the Parent Entity which entails the system adjusting the user's standing based on the system algorithm at 502, the system keeping track of a candidate's high placement and giving a special indicator so that other users know this candidate was close at 504, and allowing the candidate to continue on in the future to participate in other elections at 506. The Parent Entity would then go back to list of remaining candidates that are still eligible and they are offered a position after the same filter process at 508. Any user that is offered a job and accepts the job at 510 is no longer eligible to participate in future elections as candidates at 512.

### Creation of the Child Entity

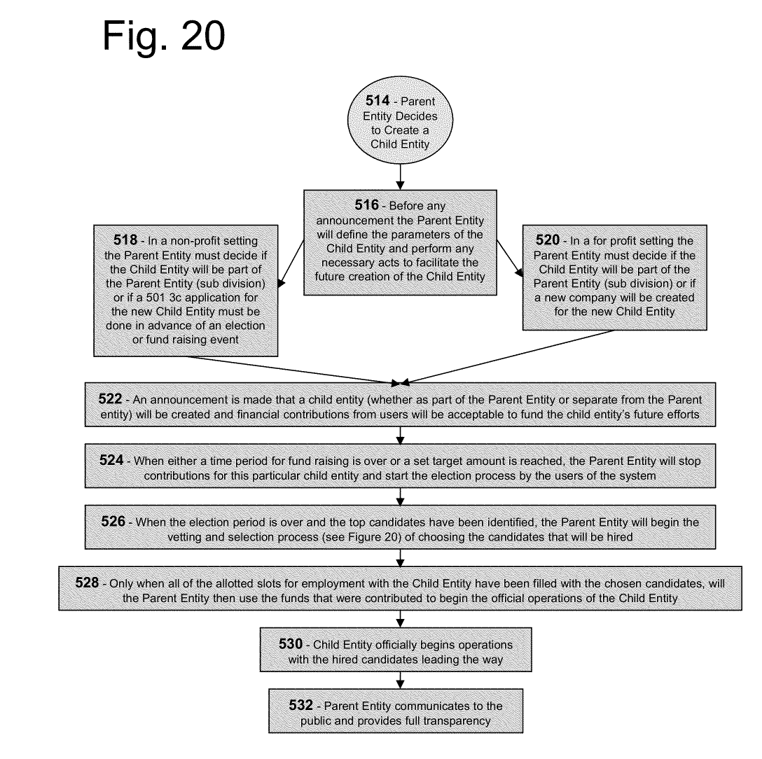

Referring now to FIG. 20, a Parent Entity decides to create a Child Entity at 514. Before any announcement the Parent Entity will define the parameters of the Child Entity and perform any necessary acts to facilitate the future creation of the Child Entity at 516. For example, in a non-profit setting the Parent Entity will decide at 518 if the Child Entity will be part of the Parent Entity (e.g., sub division, etc.) or if a 501c3 application for the new Child Entity must be done in advance of an election or fund raising event, and in a for-profit setting the Parent Entity will decide at 520 if the Child Entity will be part of the Parent Entity (e.g., sub division, etc.) or if a new company will be created for the new Child Entity.

An announcement is made at 522 that a Child Entity (whether as part of the Parent Entity or separate from the Parent Entity) will be created and financial contributions from users will be accepted to fund the Child Entity's future efforts.

Upon the occurrence of a predetermined event (e.g., when either a time period for fund raising is over or a set target amount is reached), the Parent Entity may either stop or continue to allow donations for this particular Child Entity and start the election process by the users of the system at 524. It is envisioned that the amount of donations made will be enough to fully fund the Child Entity for a significant period of time measured in years (e.g., ten, twenty or thirty years, for example).

When the Child Entity Creation Event is over and the top candidates have been identified, the Parent Entity will begin the vetting and selection process (see FIG. 19) of choosing the candidates that will be hired at 526.

Only when all of the allotted slots for employment with the Child Entity have been filled with the chosen candidates will the Parent Entity then use the funds that were contributed to begin the official operations of the Child Entity at 528. The Child Entity officially begins operations with the hired candidates leading or directing the efforts of the Child Entity at 530. The Parent Entity communicates to the public and provides full transparency at 532. The candidate selection process may take any amount of time as is necessary to complete (e.g., about 3 to 12 months). During this time period, the Parent Entity may deposit the donations with a financial institution to accrue interest until the money is distributed to the Child Entity.

Proposed implementation: Parent Entity is a 501c3 charitable organization with the purpose of supporting other charitable causes which may exist independently of the Child Entity (relief of the poor, distressed or the underprivileged; advancement of religion, advancement of education or science, erecting or maintaining public buildings, monuments or works, lessening the burdens of government, lessening neighborhood tensions, eliminating prejudice and discrimination, defending human and civil rights secured by law, and combating community deterioration and juvenile delinquency), religious, educational, scientific, literary, testing for public safety, fostering national or international amateur sports competition, and preventing cruelty to children or animals as the purposes indicated in the companies organizing document (see IRS publication i1023 in declaring as a charitable organization). The Child Entities derived from donation and selection events may be sub divisions of the Parent Entity and therefore governed by the Parent Entity or they may be new charities but governed by the Parent Entity. However, Child Entities created in other countries may be initiated as entities within that country but governed by the Parent Entity.

In yet another embodiment, the process may comprise the steps of:
a) establishing a parent entity for managing the child entity creation event wherein the child entity is either part of or not part of the parent entity;
b) establishing a web-based system that provides a website supervised by the parent entity;
c) allowing users to access the website;
d) launching a child entity creation event on the website;
e) the parent entity accepting contributions from users;
f) allowing users to register on the website;
g) allowing registered users to conduct personal activities on the website;
h) determining at least one user to receive at least part of the contributions; and
i) the parent entity distributing at least some of the contributions received in step (e) to the respective established child entity and at least some of the contributions to the at least one user of step h). The user or users selected to receive at least some of the contributions may be selected according to any desired criteria (e.g., the user's respective merit rating, how many times the respective user did a certain act, etc.).

While the invention has been described with regard to preferred embodiments thereof, it is understood that variations may be made thereto (e.g., the described features and/or steps in one embodiment may be exchanged and/or added to the described features and/or steps in other embodiments) without departing from the full spirit and scope of the invention as defined by the claims which follow.

What is claimed is:

1. A process for creating one or more child entities comprising the steps of:
a) establishing a parent entity for managing the child entity creation event, wherein the child entity is either part of or not part of the parent entity;
b) establishing a web-based system that provides a website supervised by the parent entity;
c) allowing users to access the website;
d) launching a child entity creation event on the website;
e) the parent entity accepting donations from users;
f) allowing users to register on the website;
g) allowing registered users to log personal benevolent activities on the website;
h) conducting an election whereby users may vote for other users to have the opportunity to obtain a job position with the child entity;
i) the parent entity offering a job with the child entity to one or more registered users based at least in part on the respective registered user's logged personal benevolent activities and at least in part on the number of votes a registered user has received in the election;
j) the parent entity establishing the child entity with the registered users of step (i) who accepted the parent entity's job offer; and
k) the parent entity distributing at least some of the donations received in step (e) to the respective established child entity.

2. The process of claim 1, and further comprising the step of:
a) calculating a merit rating for each registered user based on their respective logged personal benevolent activities; and
b) the parent entity offering a job with the child entity to one or more registered users based at least in part on the respective registered user's merit rating.

3. The process of claim 2 wherein said merit rating is calculated using a predetermined algorithm.

4. The process of claim 1 wherein said child entity is a charitable entity.

5. The process of claim 1 wherein steps a) through k) comprise a single child entity creation event and the parent entity conducts a plurality of child entity creation events.

6. The process of claim 5 wherein said plurality of child entity creation events are conducted in serial fashion.

7. The process of claim 1 wherein the established child entity distributes the donations over time to one or more charitable causes which exist independently of the child entity.

8. The process of claim 1 wherein said child entity is not part of the parent entity and is governed by the parent entity.

9. The process of claim 1 wherein said child entity is part of the parent entity.

10. The process of claim 1 wherein in step h), said election is conducted in multiple rounds to reduce the number of users eligible to obtain a job position with the child entity.

11. The process of claim 1 wherein registered users may perform on the website one or more of the following steps:
a.) communicate with other registered users;
b.) invite other users to access the website;
c.) question or flag other users' logged activities;
d.) verify other users' logged activities; and
e.) designate other users as noteworthy users.

12. A web-based system for creating one or more child entities, the web-based system having one or more of a presentation layer, a business logic layer, and a data storage layer, said system comprising:
a) a parent entity for managing at least one child entity creation event;
b) a server hosting a website supervised by the parent entity, said website operable to:
i.) allow users to access the website using an electronic device;
ii.) allow the parent entity to announce a child entity creation event on the website;
iii.) accept donations from users;
iv.) allow users to register on the website;
v.) allow registered users to log personal benevolent activities on the website; whereby, upon the occurrence of a predetermined event, the parent entity conducts an election whereby users may vote for other users to have the opportunity to obtain a job position with the child entity, the parent entity offering a job with the child entity to one or more registered users based at least in part on the respective registered user's logged personal benevolent activities and at least in part on the number of votes a registered user has received in the election, the parent entity establishing the child entity with the registered users of step (b.iv.) who accepted the parent entity's job offer, and the parent entity distributing at least some of the donations received in step (b.iii.) to the respective established child entity.

13. The system of claim 12, said website further operable to:
a) calculate a merit rating for each registered user based on their respective logged personal benevolent activities, the parent entity offering a job with the child entity to one or more registered users based at least in part on the respective registered user's merit rating.

14. The system of claim 13 wherein said merit rating is calculated using a predetermined algorithm.

15. The system of claim 12 wherein said child entity is a charitable entity.

16. The system of claim 12 wherein the parent entity conducts a plurality of child entity creation events.

17. The system of claim 16 wherein said plurality of child entity creation events are conducted in serial fashion.

18. The system of claim 12 wherein the established child entity distributes the donations over time to one or more charitable causes which exist independently of the child entity.

19. A process for creating one or more child entities comprising the steps of:
a) establishing a parent entity for managing the child entity creation event, wherein the child entity is either part of or not part of the parent entity;
b) establishing a web-based system that provides a website supervised by the parent entity;
c) allowing users to access the website;
d) launching a child entity creation event on the website;
e) the parent entity accepting contributions from users;
f) allowing users to register on the website;
g) allowing registered users to log personal activities on the website;
h) conducting an election whereby users may vote for other users to have the opportunity to obtain a job position with the child entity;
i) the parent entity offering a job with the child entity to one or more registered users based at least in part on the respective registered user's logged personal activities and at least in part on the number of votes a registered user has received in the election;
j) the parent entity establishing the child entity with the registered users of step (i) who accepted the parent entity's job offer; and
k) the parent entity distributing at least some of the contributions received in step (e) to the respective established child entity.

20. The process of claim 19, and further comprising the step of:
a) calculating a merit rating for each registered user based on their respective logged personal activities; and
b) the parent entity offering a job with the child entity to one or more registered users based at least in part on the respective registered user's merit rating.

21. The process of claim 20 wherein said merit rating is calculated using a predetermined algorithm.

22. The process of claim 19 wherein said child entity is a charitable entity.

23. The process of claim 19 wherein steps a) through k) comprise a single child entity creation event and the parent entity conducts a plurality of child entity creation events.

24. The process of claim 23 wherein said plurality of child entity creation events are conducted in serial fashion.

25. The process of claim 19 wherein the established child entity distributes the contributions over time to one or more charitable causes which exist independently of the child entity.

26. A process for creating one or more child entities comprising the steps of:
a) establishing a parent entity for managing the child entity creation event, wherein the child entity is either part of or not part of the parent entity;
b) establishing a web-based system that provides a website supervised by the parent entity;
c) allowing users to access the website;
d) launching a child entity creation event on the website;
e) the parent entity accepting contributions from users;
f) allowing users to register on the website;
g) allowing registered users to log personal activities on the website;
h) selecting one or more registered users for the opportunity to interview with the parent entity, the selecting step being based at least in part on the respective user's logged personal activities;
i) the parent entity offering a job with the child entity to one or more registered users based at least in part on the respective registered user's logged personal activities;
j) the parent entity establishing the child entity with the registered users of step (i) who accepted the parent entity's job offer; and
k) the parent entity distributing at least some of the contributions received in step (e) to the respective established child entity.

27. The process of claim 26, and further comprising the step of:
a) calculating a merit rating for each registered user based on their respective logged personal activities; and
b) the parent entity offering a job with the child entity to one or more registered users based at least in part on the respective registered user's merit rating.

28. The process of claim 27 wherein said merit rating is calculated using a predetermined algorithm.

29. The process of claim 26 wherein said child entity is a charitable entity.

30. The process of claim 27 wherein steps a) through k) comprise a single child entity creation event and the parent entity conducts a plurality of child entity creation events.
